(19) United States
(12) Patent Application Publication
(10) Pub. No.: US 2007/0206387 A1
(43) Pub. Date: Sep. 6, 2007

(54) Low profile lighting system

(76) Inventor: James A. Conrad, Laconia, NH (US)

Correspondence Address: Michael J. Persson at Lawson & Persson, P.C., Suite 103, 67 Water Street, Laconia, NH, 03246, US

(21) Appl. No.: 11/708,307

(22) Filed: Feb. 20, 2007

Related U.S. Application Data
(60) Provisional application No. 60/775,277, filed on Feb. 21, 2006.

(51) Int. Cl. B60Q 1/26

(52) U.S. Cl. 362/496; 362/545

(57) ABSTRACT

A vehicle lighting system for attachment to a vehicle spoiler, a vehicle spoiler and a vehicle that includes the vehicle spoiler and vehicle lighting system. The vehicle lighting system includes a light support that is shaped and dimensioned for attachment to a vehicle spoiler, and attachment means, such as screws, bolts or clips for attaching the light support to the vehicle spoiler. A plurality of light emitting diodes is attached to the light support. A substantially transparent lens is attached to the light support and dimensioned such that the lens covers the plurality of light emitting diodes. At least one electrical connector is placed in communication with the plurality of light emitting diodes and is adapted for connection to a source of electrical power of the vehicle.

This application claims the benefit of priority of U.S. Provisional Patent Application Ser. No. 60/775,277, filed on Feb. 21, 2006.

### FIELD OF THE INVENTION

The present invention relates to the field of vehicle lighting systems and, in particular to lighting systems for emergency vehicles.

### BACKGROUND OF THE INVENTION

It is common for emergency vehicles, such as police cruisers, ambulances, and roadside assistance vehicles, to stop on the shoulder of a roadway. These stops are necessary to the jobs performed by the emergency personnel, but such stops also place these personnel at a great risk of being struck by passing motor vehicles. For this reason, all emergency vehicles are equipped with special lighting systems to alert oncoming vehicles to their presence.

Traditional emergency lighting systems consisted of a single rotating flashing light mounted to the roof of the vehicle. However, these systems were readily visible to oncoming vehicles on from both sides of a roadway and resulted in vehicles traveling in opposite lanes to be unnecessarily distracted. Accordingly, current roof mounted emergency lighting systems allow emergency personnel to control the direction of illumination from the emergency lights such that, for example, they may only visible from the rear when the vehicle is stopped on the side of the road.

Despite their prevalence, roof mounted lighting systems have significant drawbacks. For example, high-intensity roof mounted lights can temporarily blind others, given their position and location. Snow can obstruct roof-mounted lighting systems, rendering them ineffective in snowy conditions. Roof mounted systems can cause vehicular roof damage and can increase the drag, and therefore, fuel consumption, of a vehicle. Roof mounted systems give the vehicle a boxy look, detracting from their aesthetic appeal. Finally, roof mounted systems are readily visible to other vehicles, which allows motorist to momentarily lower their speed when in the presence of the police vehicle and, consequently, compromises the ability of police officers to detect and apprehend dangerous drivers. For these reasons, a number of other non-roof mounted emergency lighting systems have been developed.

Conventional unmarked police vehicles typically include two flashing lights mounted inside the vehicle over the trunk proximate to the rear window. These rear window emergency lighting systems are not readily visible to drivers in front of the vehicle and generally allow the unmarked vehicles to perform their desired function, at least with regard to these drivers. However, these lights are not without their drawbacks. For example, these lights are still visible to vehicles approaching from behind, which may alert the motorist to the presence of a police officer. The placement of the lights in the rear window obstructs the view through the rear window, compromising safety. Further, in cases where the vehicle is to be used as an undercover vehicle, the lights are readily visible from outside the vehicle, which alerts onlookers to the fact that the vehicle is a police vehicle. Finally, these lights provide no means for altering traffic to move to another lane, which may be necessary in cases where a disabled vehicle blocks a roadway.

Therefore, there is a need for a lighting system for emergency vehicles that are not located so as to temporarily blind others, is not easily obstructed by snow, does not cause vehicular roof damage, doesn't detract from the aesthetic appeal of the vehicle, doesn't decrease the fuel efficiency of the vehicle as is the case roof mounted light systems, is not readily visible to other vehicles such that onlookers are aware of the fact that an undercover vehicle is a police vehicle, does not obstruct the view through the rear window of the vehicle, and that may be adapted to provide a means for altering traffic to move to another lane.

### SUMMARY OF THE INVENTION

The lighting system of the present invention was developed to equip emergency vehicles with an alternative lighting system that can be used either in conjunction with or in the place of high visibility roof-mounted emergency lights. The present invention provides added safety without compromising the integrity of the vehicle. Unlike window mounted lighting systems, this system of the present invention gives the vehicle a sleek, sporty, and low-profile look, while ensuring safety with clear, visible emergency lights. The lighting system of the present invention is readily adapted for use as an aftermarket accessory, or may be incorporated by vehicle manufactures into new vehicles.

The present invention includes a vehicle lighting system for attachment to a vehicle spoiler, a vehicle spoiler that includes the vehicle lighting system of the present invention, and a vehicle that includes the vehicle spoiler and vehicle lighting system of the present invention.

In its most basic form, the vehicle lighting system includes a light support that is shaped and dimensioned for attachment to a vehicle spoiler. Attachment means, such as screws, bolts, rivets, clips, or openings for passing screws bolts, rivets, clips or the like therethrough, are provided for attaching the light support to the vehicle spoiler. A plurality of light emitting diodes is attached to the light support and is positioned that light emitting therefrom is directed along a plane substantially parallel to, or slightly downward towards, a plane formed by a roadway upon which the vehicle rests. A substantially transparent lens is attached to the light support and dimensioned such that the lens covers the plurality of light emitting diodes. Finally, at least one electrical connector is placed in communication with the plurality of light emitting diodes and is adapted for connection to a source of electrical power of the vehicle.

The vehicle lighting system preferably includes at least one printed circuit board that is attached to the light support. The at least one of the at least one electrical connector is in electrical communication with the at least one printed circuit board and each of the plurality of light emitting diodes is attached to, and in electrical connection with, one of the at least one printed circuit board. In this embodiment, the lens is dimensioned to cover the plurality of light emitting diodes and each of the at least one printed circuit board.

In one preferred embodiment of the vehicle lighting system, the printed circuit board is a single substantially flexible printed circuit board. In these embodiments, it is likewise preferred that a layer of adhesive bond the printed circuit board to the light support.

The preferred vehicle lighting system also includes a reflector that is disposed between the light support and the light emitting diodes and reflects light from the light emitting diodes in a direction away from the light support. The reflector may take a number of forms, but is preferably has a parabolic shape and is manufactured of a plastic material to which a reflective coating is adhered. The use of a reflector is preferred because it increases the amount of light that is emitted in the direction of oncoming vehicles. However, although the use of such a reflector is preferred, such a reflector is not required and many embodiments eschew the use of reflector.

The preferred vehicle lighting system includes a first plurality of light emitting diodes of a first color and a second plurality of light emitting diodes of a second color. In these embodiments, the at least one electrical connector preferably includes a first electrical connector and a second electrical connector and the first electrical connector is in electrical communication with the first plurality of light emitting diodes and the second electrical connector is in communication with the second plurality of light emitting diodes. In some such embodiments, the first plurality of light emitting diodes are arranged in a first row, the second plurality of light emitting diodes is arranged in a second row, and the first row is disposed in substantially parallel relation to the second row. In other embodiments, the first plurality of light emitting diodes and the second plurality of light emitting diodes are arranged in alternating relation in a single row such each light emitting diode is adjacent to a light emitting diode of a different color. In still other such embodiments, a third plurality of light emitting diodes of a third color are also provided. In these embodiments, the first plurality of light emitting diodes, the second plurality of light emitting diodes, and the third plurality of light emitting diodes are preferably arranged in alternating relation in a single row such each light emitting diode is adjacent to a light emitting diode of a different color.

In some embodiments of the vehicle lighting system, the light support is shaped and dimensioned to attach to a portion of a vehicle spoiler having a spoiler mounted brake light such that one lighting system may be mounted on the vehicle spoiler on one side of the brake light and another lighting system may be mounted on the vehicle spoiler on the other side of the brake light.

The vehicle spoiler of the present invention includes the lighting system of the present invention. In some embodiments, the light support forms the housing of the spoiler and is shaped and dimensioned for attachment to the trunk of the vehicle. However, in other embodiments, the light support is a separate member that attaches to a spoiler housing. Embodiments of the vehicle spoiler of the present invention may include any of the features of the lighting system of the present invention that are discussed above.

The vehicle of the present invention includes the vehicle spoiler that includes the lighting system of the present invention. In these embodiments, the light support forms the housing of the spoiler and is attached to the trunk of the vehicle. As was the case with the vehicle spoiler, embodiments of the vehicle of the present invention may include any of the features of the lighting system of the present invention that are discussed above.

As should be readily apparent from the foregoing, the lighting system of the present invention will enhance the appearance of emergency vehicles and provide essential supplementary visibility. This system may be used on unmarked vehicles as well as marked vehicles, providing the necessary lighting, may be used by Police, Fire, Rescue, and Roadside Service vehicles, and will add an attractive look to any vehicle. The light emitting diodes will be manufactured into a sleek rear spoiler and hidden behind colorless lenses. The system can be offered in a variety of color combinations such as blue/red, red/red, blue/blue and yellow. It is envisioned that the spoiler may be offered in two styles: the raised spoiler and the trunk lid model. Dimensions and compositions may vary according to manufacturing needs and the manufacturer may determine the methods for mounting or integrating this system. This product may be offered as a retrofit for existing rescue vehicles and may also be offered as a standard or upgrade feature on rescue vehicles being newly manufactured. The low profile design will allow this product to increase the vehicle's fuel efficiency by reducing the drag on the vehicle, and ensuring that the emergency lighting system will be noticeable and apparent to approaching vehicles, regardless of snow, rain, fog, or other conditions or obstructions.

Therefore, it is an aspect of the invention to provide a lighting system for emergency vehicles that is not located so as to temporarily blind others.

It is an aspect of the invention to provide a lighting system for emergency vehicles that is not easily obstructed by snow.

It is an aspect of the invention to provide a lighting system for emergency vehicles that does not cause vehicular roof damage.

It is an aspect of the invention to provide a lighting system for emergency vehicles that doesn't detract from the aesthetic appeal of the vehicle.

It is an aspect of the invention to provide a lighting system for emergency vehicles that doesn't increase the fuel consumption of the vehicle.

It is an aspect of the invention to provide a lighting system for emergency vehicles that is not readily visible to other vehicles.

It is an aspect of the invention to provide a lighting system for emergency vehicles that does not obstruct the view through the rear window of the vehicle.

It is a still further aspect of the invention to provide a lighting system for emergency vehicles that may be adapted to provide a means for altering traffic to move to another lane.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1A is top view of one embodiment of the vehicle lighting system of the present invention with dashed lines used to show the location of the light emitting diodes through the reflector.

FIG. 1B is a cross sectional side view of the embodiment of FIG. 1 along plane A-A.

FIG. 2 is a is top view of another embodiment of the vehicle lighting system of the present invention.

FIG. 3 is a front view of one embodiment of the lighting system with the lens removed to show two rows of light emitting diodes of different colors.

FIG. 4 is a is a front view of one embodiment of the lighting system with the lens removed to show a single row of two pluralities of colored light emitting diodes arranged in alternating relation.

FIG. 5 is a is a front view of one embodiment of the lighting system with the lens removed to show a single row of three pluralities of colored light emitting diodes arranged in alternating relation.

FIG. 6 a is a front view of one embodiment of the lighting system with the lens removed to show three pluralities of colored light emitting diodes arranged in grouped relation.

FIG. 7 is a front view of one embodiment of spoiler of the present invention in which the spoiler include an integral brake light and two lighting system attached thereto.

FIG. 8 is an isometric view of one embodiment of the vehicle of the present invention.

FIG. 9 is an isometric view of another embodiment of the vehicle of the present invention.

FIG. 10 is an isometric view of another embodiment of the vehicle of the present invention.

FIG. 11 is an isometric view of another embodiment of the vehicle of the present invention.

### DETAILED DESCRIPTION OF THE INVENTION

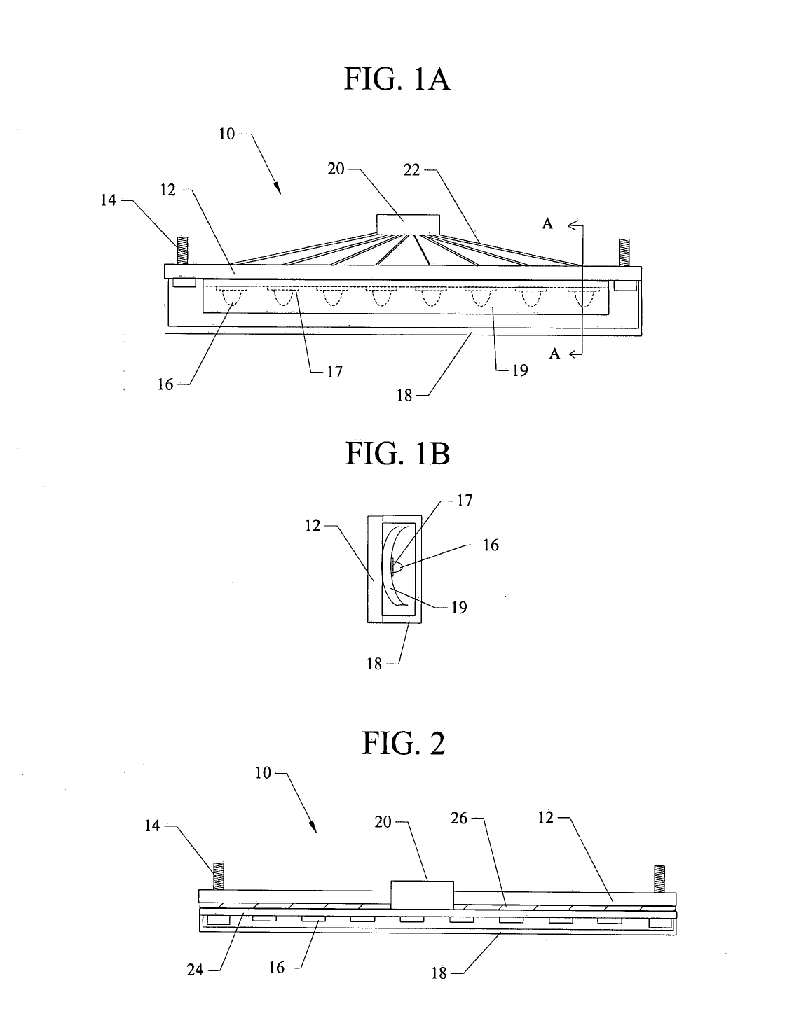

Referring first to FIGS. 1A and 1B, one embodiment of the vehicle lighting system 10 is shown. The vehicle lighting system 10 includes a light support 12 that is shaped and dimensioned for attachment to a vehicle spoiler (not shown). The light support 12 may be manufactured of plastic, aluminum, sheet steel or other materials commonly utilized to manufacture vehicle accessories. Attachment means, such as the bolts 14 shown herein, or screws, clips, rivets, or openings for passing screws bolts, rivets, clips or the like therethrough, are included for attaching the light support 12 to the vehicle spoiler.

A plurality of light emitting diodes 16 is attached to the light support 12. The light emitting diodes 16 are preferably positioned so that light emitting therefrom is directed such that said light intersects a plane formed by a roadway upon which the vehicle rests in order to avoid blinding drivers of oncoming vehicles. In the embodiment of FIGS. 1A and 1B, each light emitting diode 16 is a bulb style light emitting diode that is mounted to the light support 12 by socket 17, which includes a wire 22 that connects the light emitting diode 16 to the electrical connector 20. The electrical connector 20 is preferably a conventional vehicle light connector that connects to the vehicle's electrical system through an emergency light control system (not shown) that controls the flow of power though the connector 20 to the light emitting diodes 16.

The embodiment of the vehicle lighting system 10 of FIGS. 1A and 1B, includes a reflector 19 that is disposed between the light support 12 and the light emitting diodes 16 and reflects light from the light emitting diodes 16 in a direction away from the light support 12. As shown in FIGS. 1A and 1B, the reflector 19 has a substantially parabolic cross sectional profile. However, the reflector 19 may take a number of forms, such as a fully planar member, a slightly concave member, a planar section with two angled sections, or the like, and should not be seen as being limited to a parabolic cross section. The reflector 19 is preferably manufactured of a plastic material to which a reflective coating is adhered, in a manner similar to reflectors used with existing vehicle lights. The use of a reflector 19 is preferred because it increases the amount of light that is emitted in the direction of oncoming vehicles. However, although the use of such a reflector 19 is preferred, such a reflector is not required and many embodiments eschew the use of reflector 19 altogether.

A substantially transparent lens 18 is attached to the light support 12 and dimensioned such that the lens 18 covers the plurality of light emitting diodes 16. The lens 18 is intended to protect the light emitting diodes 16 while allowing light to pass therethrough. The lens 18 is preferably manufactured of an automotive grade plastic, such as those sold under the brand name LEXAN® by E.I. du Pont de Nemours and Company of Wilmington, Del. However, in other embodiments, the lens 18 may be manufactured of glass or other material that provides the desired protection and transparency. In some embodiments, the lens 18 is tinted with a material that reduces glare and/or hides the presence of the light emitting diodes 16. Such a tinting may take the form of a sheet of tinting material affixed to the lens 18, or of an additive to the plastic material forming the lens 18. Further, other embodiments may include a colored tinting, such as a blue, red or yellow tint, to allow high intensity white light emitting diodes 16 to produce light of the desired color. Thus, although the term “substantially transparent” is used in connection with the lens 18, this term intended to mean that light from the light emitting diodes 16 is allowed to pass through the lens 18 and not that the lens 18 is of a clear material that allows the light emitting diodes 16 to be clearly viewed through the lens when they are not illuminated

Referring now to FIG. 2, the vehicle lighting system 10 preferably includes at least one printed circuit board 24 that is attached to the light support 12. The electrical connector 20 is in electrical communication with the printed circuit board 24 and each of the plurality of light emitting diodes 16 is attached to the printed circuit board 24 and in electrical connection with the electrical connector 20 thought the printed circuit board. In this embodiment, the lens 18 is dimensioned to cover the printed circuit board 24 plurality of light emitting diodes 16 as well as the printed circuit board 24.

In the embodiment of FIG. 2, the printed circuit board 24 is a substantially flexible printed circuit board 24 that is bonded to the light support 12 by a layer 26 of adhesive. In this embodiment, the light emitting diodes 16 are surface mounted to the printed circuit board 24 using conventional surface mounting technology. However, in other embodiments, the printed circuit board 24 may be a conventional through-hole type printed circuit board and the light emitting diodes 16 may be through-hole mounted and wave soldered to the printed circuit board 24. In such embodiments, the printed circuit board may be in planar form, or may be shaped to conform to the light support 12. In still other embodiments, multiple printed circuit boards 24 are utilized and are combined to confirm to the shape of the light support 12.

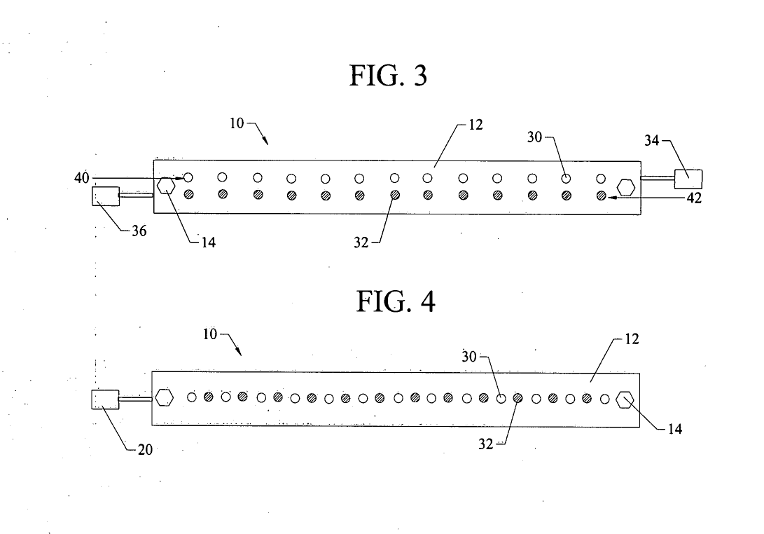

Referring now to FIGS. 3 and 4, the preferred vehicle lighting system 10 includes a first plurality 30 of light emitting diodes 16 of a first color and a second plurality 32 of light emitting diodes 16 of a second color. In the embodiment of FIG. 3, a first electrical connector 34 and a second electrical connector 36 are provided, with the first electrical connector 34 in electrical communication with the first plurality 32 of light emitting diodes 16 and the second electrical connector 36 in communication with the second plurality 32 of light emitting diodes 16. However, in the embodiment of FIG. 4, a single electrical connector 20 connects both the first plurality 30 and second plurality 32 of light emitting diodes 34.

In the embodiment of FIG. 3, the first plurality 30 of light emitting diodes 30 are arranged in a first row 40, the second plurality 32 of light emitting diodes 32 is arranged in a second row 42, and the first row 40 is disposed in substantially parallel relation to the second row 42. However, in the embodiment of FIG. 4, the first plurality of light emitting diodes 30 and the second plurality of light emitting diodes 32 are arranged in alternating relation in a single row such each light emitting diode 30, 32 is adjacent to a light emitting diode 30, 32 a different color.

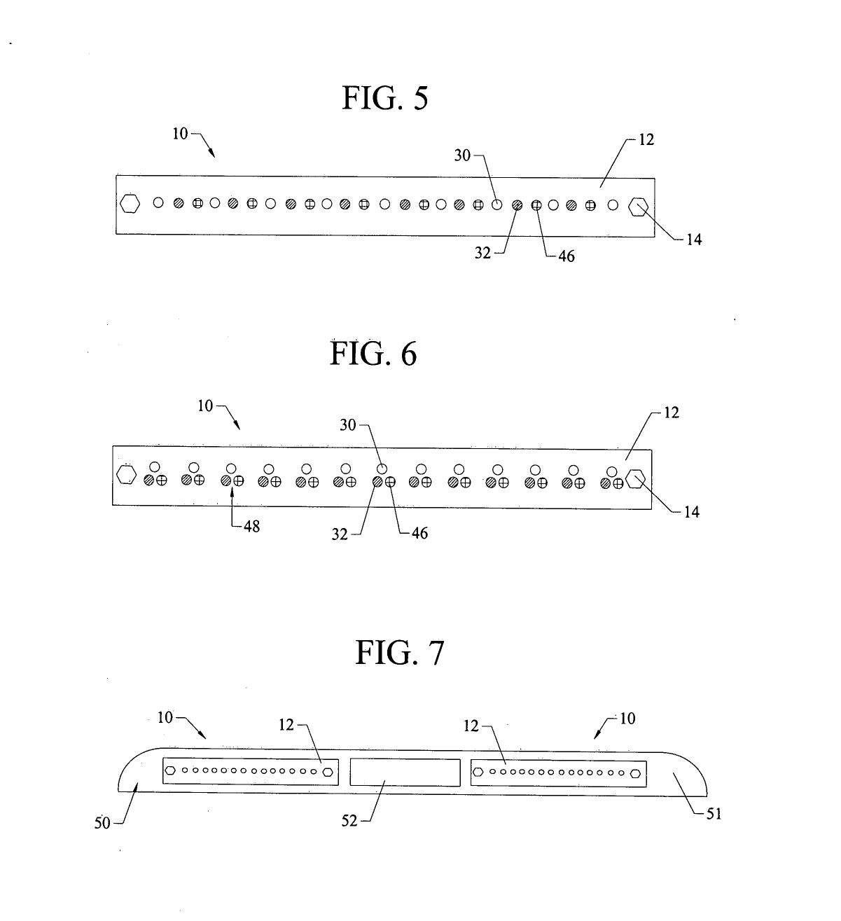

Referring now to FIGS. 5 and 6, a third plurality of light emitting diodes 46 of a third color may also be included also provided. The preferred such embodiment of FIG. 5, the first plurality of light emitting diodes 30, the second plurality of light emitting diodes 32, and the third plurality of light emitting diodes 46 are preferably arranged in alternating relation in a single row such each light emitting diode 30, 32, 46 is adjacent to a light emitting diode 30, 32, 46 of a different color. However, as shown in FIG. 6, other embodiments utilize distinct groups 48 of all three pluralities of light emitting diodes 30, 32, 46.

As shown in FIG. 7, the light support 12 is shaped and dimensioned to attach to, or be integrated as a part of, a vehicle spoiler 50 having a spoiler mounted brake light 52 such that one lighting system 12 may be mounted on the vehicle spoiler 50 on one side of the brake light 52 and another lighting system 12 may be mounted on the vehicle spoiler 50 on the other side of the brake light 52. In the embodiment of FIG. 7, the spoiler housing 51 is separate from the light support 12, and the light support 12 of each lighting system 10 is attached to the spoiler housing 51. However, in other embodiments, the light support 12 is formed integral to the spoiler housing 51.

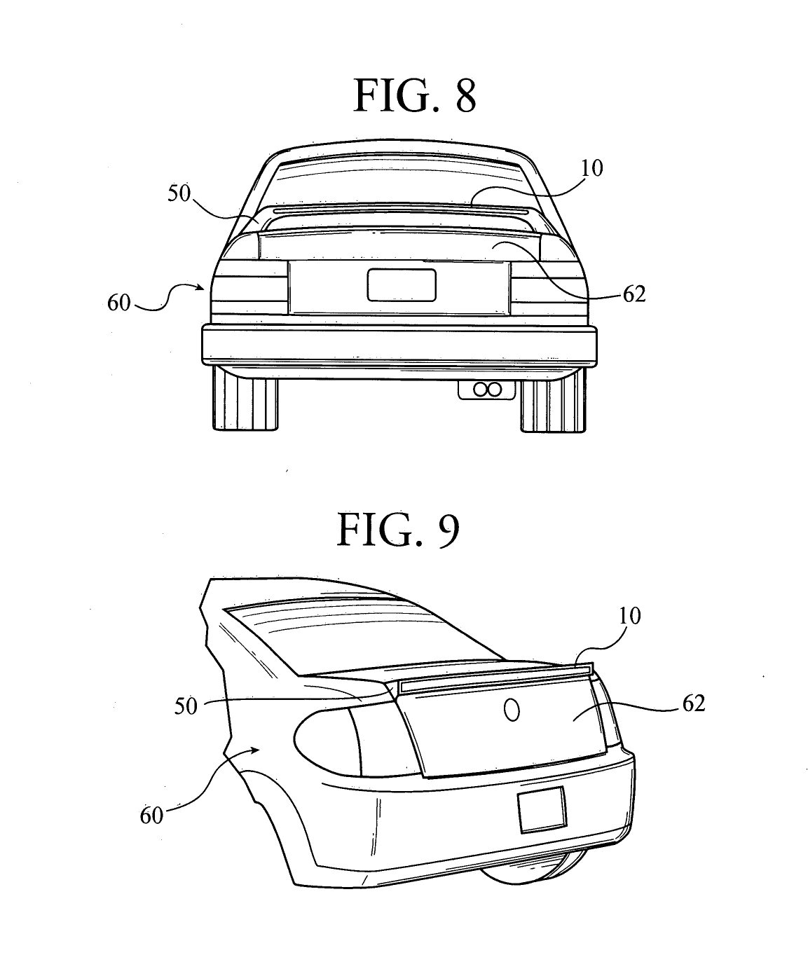

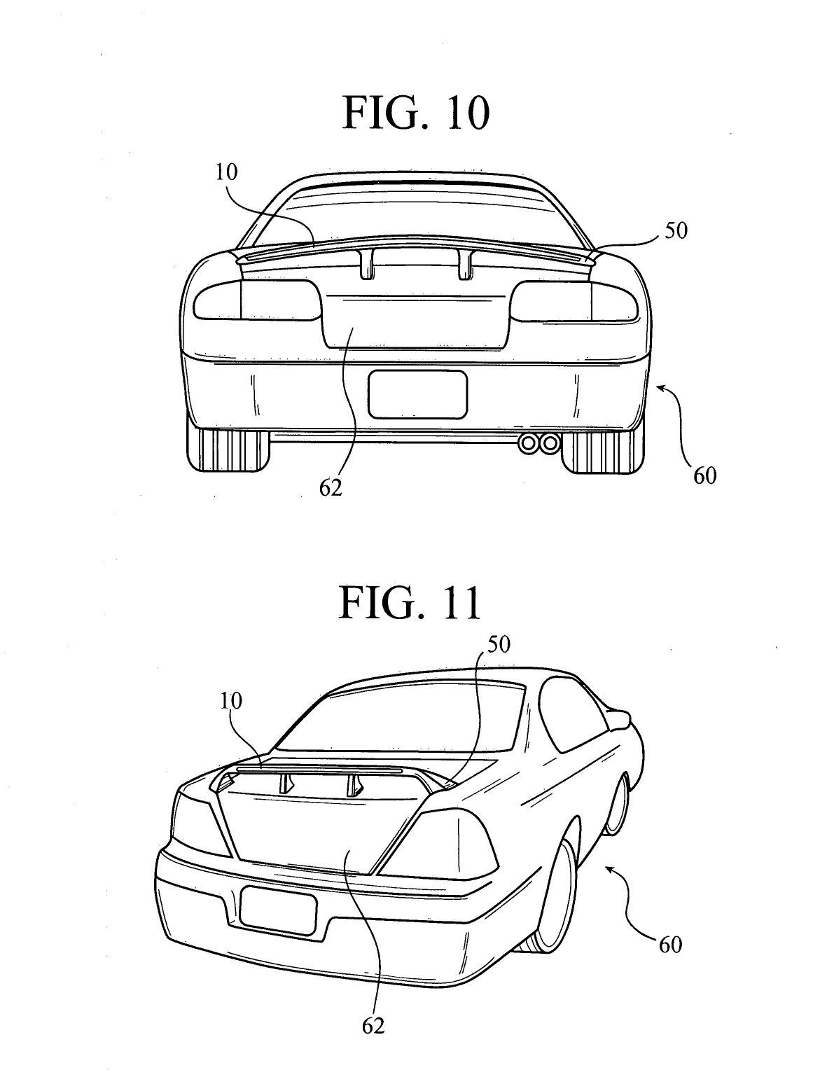

FIGS. 8-10 show the lighting system 10 and spoiler 50 of the present invention mounted to a trunk 62 of a vehicle 60. The spoiler 50 may be mounted in a flush arrangement with the trunk 60, as shown in FIG. 9, or may be a raised spoiler 50 such as those shown in FIGS. 8, 10 and 11. As is readily apparent, the types of vehicles 60 to which the spoiler 50 may be mounted are varied, as are the shapes and sizes of the spoilers themselves. Accordingly, the present invention should not be limited to any particular vehicle 60 or type of trunk mounted spoiler.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A vehicle lighting system for attachment to a vehicle spoiler comprising:
a light support, said light support being shaped and dimensioned for attachment to the vehicle spoiler and comprising attachment means for attaching said light support to said vehicle spoiler;
a plurality of light emitting diodes attached to said light support;
a substantially transparent lens attached to said light support and dimensioned such that said lens covers said plurality of light emitting diodes; and
at least one electrical connector in communication with said plurality of light emitting diodes and adapted for connection to a source of electrical power of said vehicle;
wherein said plurality of light emitting diodes are disposed such that light emitted from said plurality of light emitting diodes intersects a plane formed by a roadway upon which the vehicle rests.

2. The vehicle lighting system as claimed in claim 1 further comprising at least one printed circuit board attached to said light support, wherein each of said plurality of light emitting diodes is attached to, and in electrical connection with, one of said at least one printed circuit board, wherein at least one of said at least one electrical connector is in electrical communication with said at least one printed circuit board, and wherein said lens is dimensioned to cover said plurality of light emitting diodes and each of said at least one printed circuit board.

3. The vehicle lighting system as claimed in claim 2 wherein said at least one printed circuit board comprises one printed circuit board, wherein said printed circuit board is a substantially flexible printed circuit board and wherein said lighting system further comprises a layer of adhesive bonding said printed circuit board to said light support.

4. The vehicle lighting system as claimed in claim 1 further comprising a reflector attached to said light support and disposed between said light support and said plurality of light emitting diodes.

5. The vehicle lighting system as claimed in claim 1 wherein said plurality of light emitting diodes comprises a first plurality of light emitting diodes of a first color and a second plurality of light emitting diodes of a second color.

6. The vehicle lighting system as claimed in claim 5 wherein said at least one electrical connector comprises a first electrical connector and a second electrical connector and wherein said first electrical connector is in electrical communication with said first plurality of light emitting diodes and said second electrical connector is in communication with said second plurality of light emitting diodes.

7. The vehicle lighting system as claimed in claim 5 wherein said first plurality of light emitting diodes are arranged in a first row, said second plurality of light emitting diodes is arranged in a second row, and said first row is disposed in substantially parallel relation to said second row.

8. The vehicle lighting system as claimed in claim 5 wherein said first plurality of light emitting diodes and said second plurality of light emitting diodes are arranged in alternating relation in a single row such each light emitting diode is adjacent to a light emitting diode of a different color.

9. The vehicle lighting system as claimed in claim 5 further comprising a third plurality of light emitting diodes of a third color.

10. The vehicle lighting system as claimed in claim 9 wherein said first plurality of light emitting diodes, said second plurality of light emitting diodes, and said third plurality of light emitting diodes are arranged in alternating relation in a single row such each light emitting diode is adjacent to a light emitting diode of a different color.

11. The vehicle lighting system as claimed in claim 1 wherein said light support is shaped and dimensioned to attach to a portion of a vehicle spoiler having a spoiler mounted brake light such that one lighting system may be mounted on the vehicle spoiler on one side of the brake light and another lighting system may be mounted on the vehicle spoiler on the other side of the brake light.

12. A vehicle spoiler for attachment to a trunk of a vehicle, said vehicle spoiler comprising:
a spoiler housing shaped and dimensioned for attachment to the trunk of the vehicle, said spoiler housing comprising attachment means for attaching said light support to the trunk of the vehicle;
a plurality of light emitting diodes attached to said spoiler housing;
a substantially transparent lens attached to said spoiler housing and dimensioned such that said lens covers said plurality of light emitting diodes; and
at least one electrical connector in communication with said plurality of light emitting diodes and adapted for connection to a source of electrical power of said vehicle;
wherein said plurality of light emitting diodes are disposed such that light emitted from said plurality of light emitting diodes intersects a plane formed by a roadway upon which the vehicle rests.

13. The vehicle spoiler as claimed in claim 12 further comprising at least one light support attached to said spoiler housing and at least one printed circuit board attached to said light support, wherein each of said plurality of light emitting diodes is attached to, and in electrical connection with, one of said at least one printed circuit board, wherein at least one of said at least one electrical connector is in electrical communication with said at least one printed circuit board, and wherein said lens is dimensioned to cover said plurality of light emitting diodes and each of said at least one printed circuit board.

14. The vehicle spoiler as claimed in claim 13 wherein said at least one printed circuit board comprises at least one substantially flexible printed circuit board and wherein said lighting system further comprises a layer of adhesive bonding said printed circuit board to said light support.

15. The vehicle spoiler as claimed in claim 12 wherein said plurality of light emitting diodes comprises a first plurality of light emitting diodes of a first color and a second plurality of light emitting diodes of a second color.

16. The vehicle spoiler as claimed in claim 15 wherein said at least one electrical connector comprises a first electrical connector and a second electrical connector and wherein said first electrical connector is in electrical communication with said first plurality of light emitting diodes and said second electrical connector is in communication with said second plurality of light emitting diodes.

17. The vehicle spoiler as claimed in claim 12 further comprising a reflector attached to said spoiler housing, wherein said reflector is disposed between said spoiler housing and said plurality of light emitting diodes.

18. A vehicle comprising:
a vehicle spoiler attached to a trunk of the vehicle, said vehicle spoiler comprising:
a spoiler housing attached to the trunk of the vehicle;
a plurality of light emitting diodes attached to said spoiler housing;
a substantially transparent lens attached to said spoiler housing and dimensioned such that said lens covers said plurality of light emitting diodes; and
at least one electrical connector in communication with said plurality of light emitting diodes and adapted for connection to a source of electrical power of said vehicle;
wherein said plurality of light emitting diodes are disposed such that light emitted from said plurality of light emitting diodes intersects a plane formed by a roadway upon which the vehicle rests.

19. The vehicle as claimed in claim 18 wherein said vehicle spoiler further comprises a light support attached to said spoiler housing and at least one printed circuit board attached to said light support, wherein each of said plurality of light emitting diodes is attached to, and in electrical connection with, one of said at least one printed circuit board, wherein at least one of said at least one electrical connector is in electrical communication with said at least one printed circuit board, and wherein said lens is dimensioned to cover said plurality of light emitting diodes and each of said at least one printed circuit board.

20. The vehicle as claimed in claim 18 further comprising a reflector attached to said spoiler housing, wherein said reflector is disposed between said spoiler housing and said plurality of light emitting diodes.
